(19) United States
(12) Patent Application Publication
(10) Pub. No.: US 2012/0317421 A1
(43) Pub. Date: Dec. 13, 2012

(54) Fingerprinting Executable Code

(75) Inventor: Alexander G. Gounares, Kirkland, WA (US)

(73) Assignee: CONCURIX CORPORATION, Kirkland, WA (US)

(21) Appl. No.: 13/526,723

(22) Filed: Jun. 19, 2012

(51) Int. Cl. G06F 21/00

(52) U.S. Cl. 713/189

(57) ABSTRACT

Executable code may be fingerprinted by inserting NOP codes into the executable code in a pattern that may reflect a fingerprint. The NOP codes may be single instructions or groups of instructions that perform no operation. A dictionary of NOP codes and their corresponding portion of a fingerprint may be used to create a series of NOP codes which may be embedded into executable code. The fingerprinted executable code may be fully executable and the presence of the NOP codes may not be readily identifiable. The fingerprinting mechanism may be used to authenticate executable code in various scenarios.

### BACKGROUND

Executable code contains instructions for computer processors. In many cases, verification and control of executable code may be performed using metadata. These metadata may include checksums, hash function values, file names, or other metadata. In some cases, executable code may be controlled by encrypting the executable code so that a decryption operation may be performed prior to using the code.

### SUMMARY

Executable code may be fingerprinted by inserting NOP codes into the executable code in a pattern that may reflect a fingerprint. The NOP codes may be single instructions or groups of instructions that perform no operation. A dictionary of NOP codes and their corresponding portion of a fingerprint may be used to create a series of NOP codes which may be embedded into executable code. The fingerprinted executable code may be fully executable and the presence of the NOP codes may not be readily identifiable. The fingerprinting mechanism may be used to authenticate executable code in various scenarios.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a mechanism for fingerprinting executable code

FIG. 2 is a diagram illustration of an embodiment showing a network environment for fingerprinting executable code.

FIG. 3 is a flowchart illustration of an embodiment showing a method for retrieving a pattern from executable code.

FIG. 4 is a flowchart illustration of an embodiment showing a method for translating a pattern into a fingerprint.

FIG. 5 is a flowchart illustration of an embodiment showing a method for fingerprinting executable code using a hash value for the executable code.

FIG. 6 is a flowchart illustration of an embodiment showing a method for authenticating executable code using an extracted fingerprint.

FIG. 7 is a timeline illustration of an embodiment showing a method for distributing executable code with fingerprints.

### DETAILED DESCRIPTION

Executable code may be fingerprinted by inserting NOP codes into the executable code. The placing and/or sequence of the NOP codes may create a pattern which may represent a fingerprint. In one use scenario, the fingerprint may be used to authenticate the executable code.

The pattern of NOP codes may represent a fingerprint, which may be expressed in any type of data, including binary data, numerical data, text data, or other data types. A dictionary may translate the pattern of NOP codes to a fingerprint by matching a placement or specific NOP code with a portion of the fingerprint.

A client device may receive executable code and may verify the code by extracting a pattern of NOP codes, translating the pattern to a fingerprint, and using the fingerprint to authenticate the executable code.

The fingerprint may be used to make different decisions about the executable code. In some cases, the fingerprint may be used to authenticate the code, determine whether or not to execute the code, determine provenance of the code, identify an owner or source of the code, or other scenarios.

In one scenario, the fingerprint may be encrypted using the client device's public encryption key and a server device's private key. In the scenario, the client device may be able to decrypt using its private key and the server's public key to authenticate that both the server device created the fingerprint and that the executable code was intended for use by the client device.

In another scenario, the fingerprint may represent a hash value of the entire executable code. A server device may perform a hash function on the executable code to create a fingerprint, then embed the fingerprint in the executable code to create fingerprinted executable code. A client device may receive the executable code, extract and remove the fingerprint, then perform the same hash function and compare the results to the fingerprint.

In still another scenario, the fingerprint may be an identifier for a sending device or a supplier of the executable code. In such a scenario, the fingerprint may be used to verify the provenance of the executable code.

The NOP codes may be single instructions or groups of instructions. An example of a single instruction may add zero to a register. An example of a group of instructions may add one to a register in a first instruction and subtract one from the same register in the following instruction. In some cases, the NOP codes may indistinguishable from executable codes that perform various functions. As such, some embodiments may add fingerprints to executable code that may be difficult to detect unless a dictionary of known NOP codes or sequences of NOP codes is available.

For the purposes of this specification and claims, the term “executable element” may define a set of instructions that may be executed by a processor. In a typical embodiment, an executable element may be machine level commands that may be sent to a processor. A single computer application may be made up of many executable elements. An executable element may also be referred to as a job, application, code chunk, or other term.

Throughout this specification, the term “fingerprint” is used to identify a code of some sort that may be added to executable code. The code may be represented in the executable code using NOP codes using various mechanisms. Another synonym for “fingerprinting” used in the industry may be “watermarking”.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

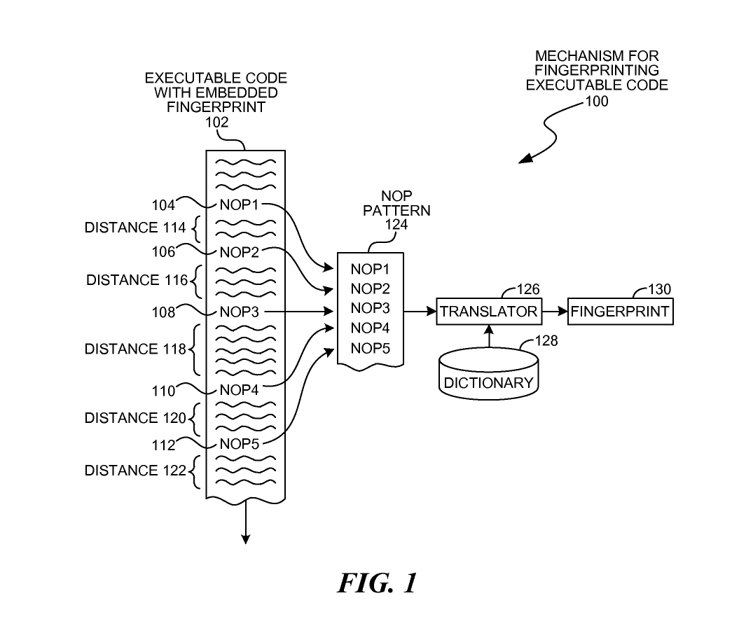

FIG. 1 is a diagram of an embodiment 100 showing an example process for reading a fingerprint from executable code. Embodiment 100 is a simplified example of extracting a pattern from executable code and translating the pattern to create a fingerprint.

A set of executable code 102 may be illustrated with a series of executable commands and several NOP codes 104-112 embedded in the executable code 102. The NOP codes 104-122 may be individual statements that perform no function or groups of statements that perform no function. In a simple example, a single command that performs no function may add zero to a register. A group of commands that may perform no function may subtract one from a register in a first command, then add one to the same register in a second command.

Single NOP commands may be detectable, as the effectiveness of each statement may be analyzed to determine if the command caused any change. However, multiple commands that perform no function may be more difficult to detect, as each command may perform a change, but a subsequent command may perform the inverse change. Such groups of commands may be difficult to detect that the executable code 102 has been fingerprinted.

Difficult to detect fingerprints may be useful in several scenarios. For example, an executable code 102 may be created for and licensed to a specific user. In the scenario, the user may be the only user who purchased a license to the executable code 102 and the user may not be permitted to share or distribute the executable code 102. The user may remove or change metadata or perform other modifications to the executable code in an effort to nefariously distribute the code. When the owner of the executable code 102 detects a copy of the executable code 102, the owner may be able to identify the copy of the executable code 102 by detecting and evaluating the fingerprint. Because the fingerprint may be difficult to detect, users may not realize how the executable code 102 is identified.

The executable code 102 may be any type of executable code. In some cases, the executable code 102 may be machine code that is decompiled into assembler or other low level language prior to inserting the NOP codes. In other cases, the executable code 102 may be intermediate code that may be compiled at runtime. In still other cases, the executable code 102 may be source code that may be compiled prior to execution.

The NOP codes 104-112 may be dispersed throughout the executable code 102. In the example of embodiment 100, the NOP codes 104-112 are separated by various distances 114-122. Each of the distances 114-122 may be a number of instructions between the various NOP codes. A fingerprint extractor may scan the executable code 102 to identify each NOP code and, in some embodiments, determine a distance between each NOP code. From the scan of the executable code 102, a NOP pattern 124 may be created.

The NOP pattern 124 may be a series of NOP commands, which a translator 126 in conjunction with a dictionary 128, may create a fingerprint. In some embodiments, the pattern 124 may be a sequence of NOP commands 104-112 and/or a sequence of distances 114-122. Some embodiments may use the sequence of NOP commands to identify a fingerprint. In such an embodiment, the distances between NOP commands may be ignored.

Other embodiments may use the distances 114-122 to identify a fingerprint. In such embodiments, the distances 114-122 may be placed in the pattern 124 and the NOP commands may be ignored. For example, a simple numerical sequence may be created by a pattern of distances 114-122, and the numerical sequence may be used as a fingerprint.

In still other embodiments, the combination of a NOP command and a distance may be used to identify a fingerprint. For example, a dictionary 128 may include entries that have a combination of distance and NOP commands to translate to a portion of a fingerprint. Some embodiments may create a numerical fingerprint from the sequence of distances and different fingerprint from a sequence of NOP commands.

In some embodiments, a dictionary 128 may identify distances between NOP commands using a range of distances. Some situations may occur where a NOP command may not be able to be placed at an exact distance from a previous NOP command. In such a situation, a NOP command may be placed within a certain range of distances.

The translator 126 and dictionary 128 may generate a fingerprint 130 from the pattern 124. The dictionary 128 may contain a table of entries where a portion of a fingerprint may be represented by entries that may be found in the pattern 124. In a typical embodiment, an entry may have a NOP command and a representative portion of a fingerprint. For example, a specific NOP command may correspond to a bit, byte, word, or other binary element. In another example, a NOP command may correspond with a numerical digit, text string, number sequence, or other data element.

In a simple embodiment, the dictionary may have 2 entries, each corresponding to one of two different NOP commands. In such an embodiment, the pattern may be a series of bits that may be interpreted as a fingerprint.

In another embodiment, the dictionary may have 8 or 16 entries, where each entry may represent a different byte or word. The series of bytes or words may be used as a fingerprint.

In still other embodiments, the dictionary may have 32, 64, 128, or more entries.

The translator 126 may operate in a simple version by identifying an entry in the pattern 124, looking up the pattern entry in the dictionary 128, and returning the fingerprint element. As each fingerprint element is identified, the elements may be appended to the fingerprint to create a fingerprint of any length.

Embodiment 100 illustrates an embodiment where the NOP commands are dispersed throughout the executable code 102. In some embodiments, the NOP commands may be grouped together into a single pattern 124 which may be embedded in the executable code 102.

Embodiment 100 illustrates how a fingerprint may be extracted from executable code. A reverse mechanism may be used to translate a fingerprint into a pattern and embed the pattern into the executable code.

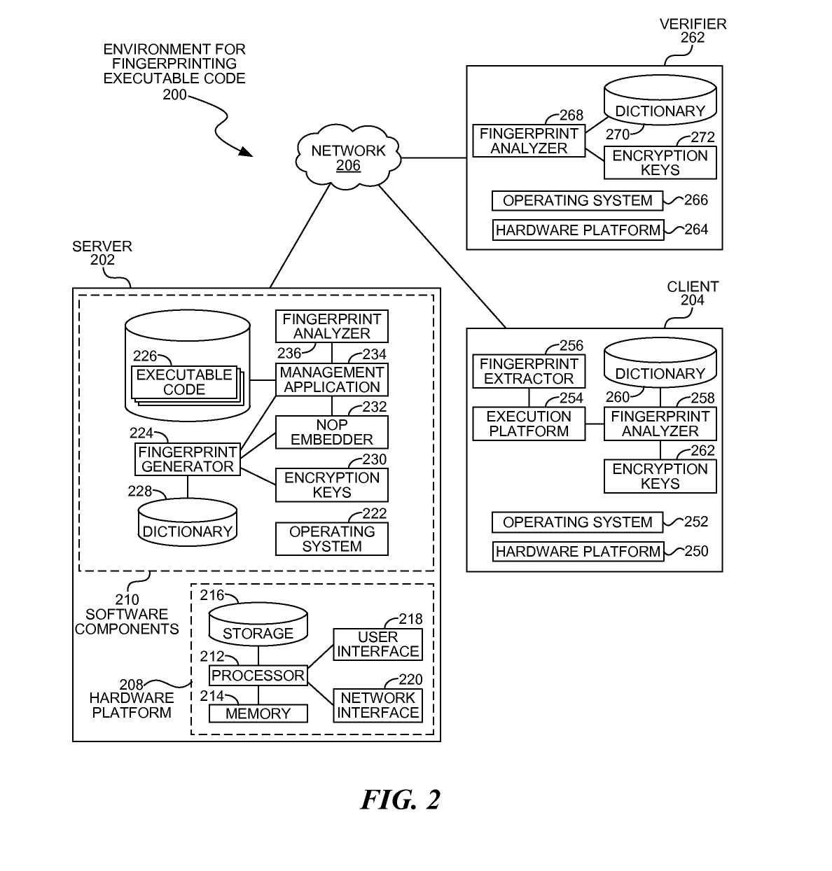

FIG. 2 is a diagram illustration of an embodiment 200 showing a network environment in which fingerprinting of executable code may be used. Embodiment 200 is an example embodiment showing a server 202 and client 204, where the server 202 may create executable code with a fingerprint and client 204 may examine and confirm the fingerprint embedded in the executable code.

The diagram of FIG. 2 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a server 202 that may create fingerprinted executable code and a client 204 that may examine executable code to extract a fingerprint.

The server 202 is illustrated having a hardware platform 208 and software components 210. The server 202 as illustrated represents a conventional computing device, although other embodiments may have different configurations, architectures, or components.

In many embodiments, the server 202 may be a server computer. In some embodiments, the server 202 may still also be a desktop computer, laptop computer, netbook computer, tablet or slate computer, wireless handset, cellular telephone, game console or any other type of computing device.

The hardware platform 208 may include a processor 212, random access memory 214, and nonvolatile storage 216. The hardware platform 208 may also include a user interface 218 and network interface 220. The processor 212 may be made up of several processors or processor cores in some embodiments. The random access memory 214 may be memory that may be readily accessible to and addressable by the processor 212. The nonvolatile storage 216 may be storage that persists after the device 102 is shut down. The nonvolatile storage 216 may be any type of storage device, including hard disk, solid state memory devices, magnetic tape, optical storage, or other type of storage. The nonvolatile storage 216 may be read only or read/write capable.

The user interface 218 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 220 may be any type of connection to another computer. In many embodiments, the network interface 220 may be a wired Ethernet connection. Other embodiments may include wired or wireless connections over various communication protocols.

The software components 210 may include an operating system 222 on which various applications and services may operate. An operating system may provide an abstraction layer between executing routines and the hardware platform 208, and may include various routines and functions that communicate directly with various hardware components.

The server 202 may have a fingerprint generator 224 which may receive executable code 226, generate a fingerprint, and create a pattern of NOP codes. A NOP embedder 232 may embed the pattern of NOP codes into the executable code. The fingerprint generator 224 may use a dictionary 228, which may contain a conversion table that can be used to convert between fingerprints and patterns of NOP codes.

In some embodiments, the fingerprint may include encrypted data that may be encrypted using public/private key encryption systems. For example, a fingerprint may include information that may be encrypted using a sender's private key. Such a fingerprint may be decrypted by a receiving device using the sender's public key. Such an example may verify the sender's identity through the fingerprint, thus authenticating the executable code.

In another example, a sender may encrypt a fingerprint using a recipient's public key. Once extracted from the executable code by the recipient, the recipient may decrypt the fingerprint using the recipient's private key. Such an example may allow only the intended recipient to have access to the fingerprint.

In still another example, a sending device may encrypt the fingerprint with a recipient's public key and the sender's private key. The recipient may decrypt the fingerprint using the sender's public key and the recipient's private key. Such an example may allow only the intended recipient to access the fingerprint, and the fingerprint may be authenticated to have come from the sender.

A management application 234 may manage the fingerprinting of executable code 226. The management application 234 may receive requests for executable code, determine the appropriate types of fingerprinting, and cause the executable code to be fingerprinted. In some embodiments, the management application 234 may also distribute the fingerprinted code to various client devices.

The client 204 may be connected to the server 202 through a network 206.

The client 204 may be a server computer. In some embodiments, the client 204 may still also be a desktop computer, laptop computer, netbook computer, tablet or slate computer, wireless handset, cellular telephone, game console or any other type of computing device.

The client 204 may have a hardware platform 250 similar to the hardware platform 208 of the server 202. The client 204 may have various software components, including an operating system 252 on which various applications and services may operate. An operating system may provide an abstraction layer between executing routines and the hardware platform 250, and may include various routines and functions that communicate directly with various hardware components.

The client 204 may have an execution platform 254 in which executable code may be executed. The execution platform 254 may be a virtual machine, interpreter, or other system in which the executable code may be run. In some embodiments, the functions of the execution platform 254 may be performed by the operating system 252.

The execution platform 254 may launch a fingerprint extractor 256 to extract a pattern of NOP codes from a set of executable code. A fingerprint analyzer 258 may receive the extracted pattern provided by the fingerprint extractor 256. The fingerprint analyzer 258 may use a dictionary 260 and, in some embodiments, a set of encryption keys 262 to determine the fingerprint from the extracted pattern.

In some embodiments, a client 204 may extract a pattern and pass the pattern over the network 206 to a verifier 262. The verifier 262 may perform the conversion from a pattern to a fingerprint.

The verifier 262 may have a hardware platform 264 and an operating system 266 in a similar fashion as the server 202. The verifier 262 may have a fingerprint analyzer 268, dictionary 270, and encryption keys 272 to perform the function of converting or translating an extracted pattern into a fingerprint.

The verifier 262 may be used in embodiments where a client 204 may not have sufficient processing capabilities to analyze executable code. In some embodiments, the verifier 262 may be used in cases where a dictionary may not be distributed to various devices but may have limited distribution to only trusted devices. Such an embodiment may be useful when the dictionary is considered to be a security component.

In some embodiments, a server 202 may also have a fingerprint analyzer 236, which may receive patterns extracted by a client 204 and may return the fingerprint.

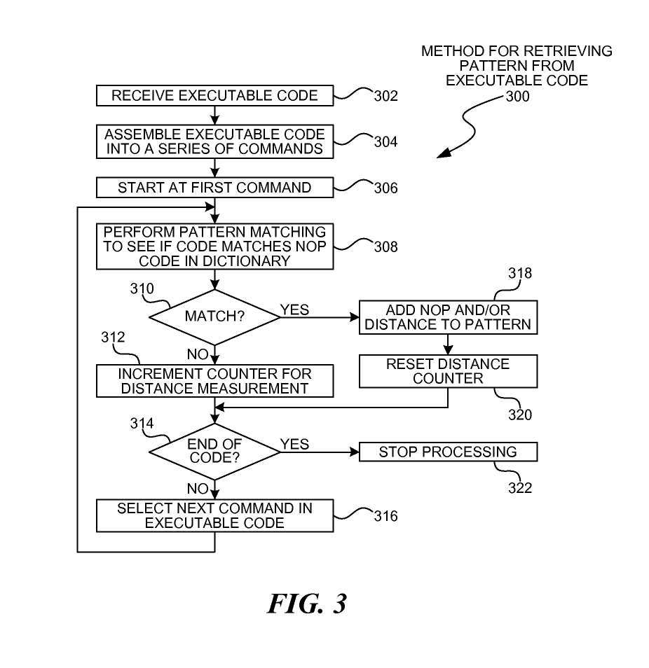

FIG. 3 is a flowchart illustration of an embodiment 300 showing a method for retrieving a pattern from executable code. Embodiment 300 illustrates the operations of a fingerprint extractor, such as the fingerprint extractor 256 of embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates a method by which a pattern of NOP codes may be extracted from executable code. The pattern may include both the NOP codes identified in the executable code as well as distances between sequential NOP codes.

In block 302, executable code may be received.

The executable code may be assembled in block 304 into a series of commands. In some embodiments, executable code may be transmitted in several files. The files may be organized into a single sequential list of commands in block 304 so that the extraction process may be performed over the entire group of files. In one embodiment, the file names may be arranged alphabetically by file name.

The first command may be selected in block 306.

Pattern matching may be performed in block 308 to determine if the current command in the executable code matches any of the various NOP codes defined in a dictionary. If there is no match in block 310, a counter may be incremented in block 312 for the distance measurement. If the end of the code has not been reached in block 314, the next command may be selected in block 316 and the process may loop back to block 308.

The process may cycle through each command in the executable code until a match is found. Once a match is found in block 310, the NOP code and/or the distance measurement may be added to the pattern in block 318. The distance counter may be reset in block 320, and the process may continue at block 314.

Once all of the commands in the executable code have been processed in block 314, the process may end in block 322.

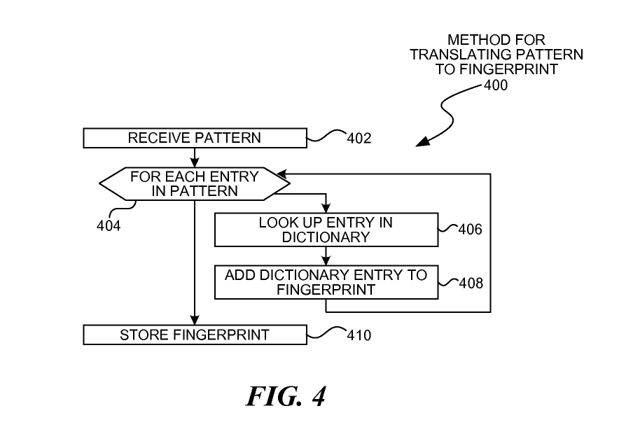

FIG. 4 is a flowchart illustration of an embodiment 400 showing a method for translating a pattern into a fingerprint. Embodiment 400 illustrates the operations of a fingerprint analyzer, such as the fingerprint analyzers 258, 268, or 236 of embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates a simple line by line translation of a NOP pattern into a fingerprint using a dictionary. Other embodiments may have different mechanisms for translating between a NOP pattern and a fingerprint.

The pattern may be received in block 402. Each entry in the pattern may be examined in sequence in block 404.

For each entry in block 404, the entry may be looked up in a dictionary in block 406 and the dictionary entry may be appended to the fingerprint in block 408. After processing all of the entries in block 404, the fingerprint may be stored in block 410.

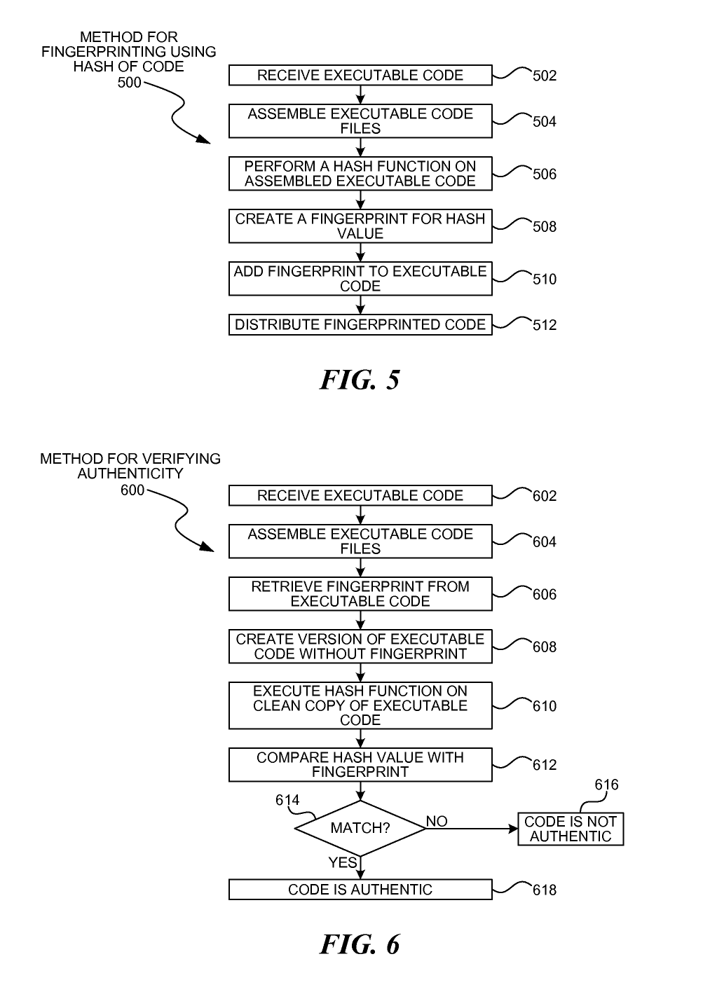

FIGS. 5 and 6 are flowchart illustrations of embodiments 500 and 600, respectively. Embodiment 500 illustrates a method for fingerprinting using a hash value, where the hash value comes from performing a hash function on the executable code. Embodiment 600 illustrates a method for verifying authenticity of the executable code by extracting the fingerprint and verifying that the executable code matches the hash value.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiments 500 and 600 illustrate one mechanism by which a fingerprint may be used to verify the executable code. The hash value representing the executable code may be embedded as a fingerprint into the executable code itself when the code is created. On the receiving end, the fingerprint may be extracted, creating a copy of the executable code without the fingerprint. The hash function may be executed on the remaining executable code and compared to the hash value of the original code. When the two hash values match, the code may be considered authentic or unchanged since the fingerprint was added.

In block 502, the executable code may be received. The executable code may be assembled into order in block 504 when the executable code may be contained in multiple files.

A hash function may be performed in block 506 on the executable code. A fingerprint may be created in block 508 using the hash function. In some embodiments, the fingerprint may be encrypted using the either or both of the sender's and recipient's encryption keys.

The fingerprint may be added to the executable code in block 510 and the code may be distributed in block 512.

In block 602, the executable code may be received by a client device. The executable code may be assembled in block 604 when the executable code may be contained in multiple files.

The fingerprint may be extracted from the executable code in block 606 and a version of the executable code may be created in block 608 where the version does not contain a fingerprint. In embodiments where the fingerprint may be encrypted, the client device may decrypt the fingerprint using the either or both of the sender's and recipient's encryption keys.

The hash function may be executed on the clean copy of the executable code in block 610 and the hash value compared to the fingerprint in block 612. When the hash value matches the fingerprint in block 614, the code may be determined to be authentic in block 618. If the hash value does not match the fingerprint in block 614, the code may not be considered authentic in block 616.

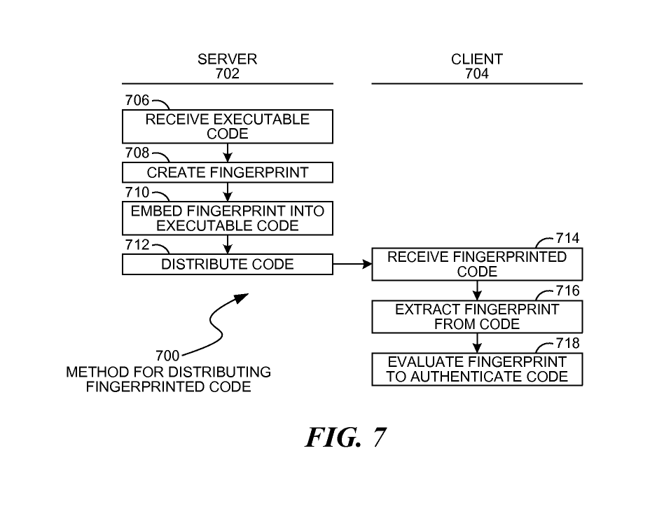

FIG. 7 is a timeline illustration of an embodiment 700 showing a method for distributing fingerprinted executable code. Embodiment 700 shows the operations of a server 702 in the left hand column and a client 704 in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 700 illustrates operations that are performed by a server 702 and client 704 in distributing executable code.

The server 702 may receive executable code in block 706 and may create a fingerprint in block 708. The fingerprint may be embedded into the executable code in block 710 and distributed in block 712.

The client 704 may receive the fingerprinted code in block 714, extract the fingerprint in block 716, and use the fingerprint in block 718 to authenticate the code.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A method comprising:
receiving executable code;
examining said executable code to identify NOP codes within said executable code;
determining a pattern for said NOP codes; and
making a decision based on said pattern.

2. The method of claim 1, said decision being to authenticate said executable code.

3. The method of claim 2 authenticate being performed by:
comparing said pattern to a pattern associated with a code supplier.

4. The method of claim 3, said pattern associated with said code supplier being a public key, said public key being associated with said code supplier.

5. The method of claim 4 further comprising decoding said pattern using a private key.

6. The method of claim 5, said private key being associated with an intended recipient for said executable code.

7. The method of claim 2, said authenticate being performed by:
removing said NOP codes from said executable code to create clean executable code;
performing a hash function on said clean executable code to create a hash result; and
authenticating said executable code when said hash result matches said pattern.

8. The method of claim 1, said decision being to halt execution of said executable code.

9. The method of claim 1, said decision being to identify an owner of said executable code.

10. The method of claim 1, said pattern being determined by:
identifying a first NOP code;
looking up said first NOP code in a dictionary to identify a value; and
adding said value to said pattern.

11. The method of claim 1, said pattern being defined by a sequence of NOP codes.

12. The method of claim 11, said pattern being further defined by:
determining a first location within said executable code for a first NOP code;
determining a second location within said executable code for a second NOP code;
determining a distance between said first location and said second location; and
determining a pattern entry from said distance and adding said pattern entry to said pattern.

13. The method of claim 12, said pattern entry being determined by:
comparing said distance to dictionary, said dictionary having a pattern entry associated with said distance; and
retrieving said pattern entry from said dictionary.

14. A method performed by a computer system having a processor, said method comprising:
receiving computer instruction code;
determining a fingerprint for said computer instruction code; and
creating fingerprinted executable code by inserting a plurality of NOP codes representing said fingerprint into said computer instruction code.

15. The method of claim 14, said method being performed at compile time.

16. The method of claim 14, said computer instruction code being intermediate code.

17. The method of claim 14, said computer instruction code being source code.

18. A computer system comprising:
a processor;
a fingerprint generator operable on said processor that:
receives executable code; and
generates a fingerprint for said executable code;
a NOP embedder that:
translates said fingerprint into a series of NOP instructions; and
embeds said NOP instructions into said executable code.

19. The computer system of claim 18 further comprising:
a dictionary containing NOP instructions and corresponding values, said values being portions of said fingerprint.

20. The computer system of claim 19, at least one of said NOP instructions comprising a group of NOP codes.
